(19) United States
(12) Patent Application Publication
(10) Pub. No.: US 2012/0079094 A1
(43) Pub. Date: Mar. 29, 2012

(54) System and Method for Data Transfer of Object Properties

(75) Inventors: Javeed Nizami, Plano, TX (US); Krishna Murthy Rao Terala, Milford, OH (US)

(73) Assignee: Siemens Product Lifecycle Management Software Inc., Plano, TX (US)

(21) Appl. No.: 12/888,863

(22) Filed: Sep. 23, 2010

(51) Int. Cl. G06F 15/173

(52) U.S. Cl. 709/224

(57) ABSTRACT

A system, method, and computer readable medium. A method includes monitoring calls from a client system to a server system for properties associated with an object, each call having a context. The method includes storing call data related to the calls as a property-retrieval history, including storing the context of each call. The method includes analyzing a policy associated with at least one context based on the property-retrieval history. The method includes updating the policy associated with the at least one context based on the analysis, and transferring data corresponding to the at least one context based on the policy.

### TECHNICAL FIELD

The present disclosure is directed, in general, to systems and methods for use in computer-aided design, manufacturing, engineering, prototype/test, maintenance, modeling, and visualization (individually and collectively, “CAD” and “CAD systems”) and in product lifecycle management (“PLM”) and other systems.

### BACKGROUND OF THE DISCLOSURE

Increased efficiency in data transfer between data processing systems is desirable.

### SUMMARY OF THE DISCLOSURE

Various embodiments include a system, method, and computer readable medium. A method includes monitoring calls from a client system to a server system for properties associated with an object, each call having a context. The method includes storing call data related to the calls as a property-retrieval history, including storing the context of each call. The method includes analyzing a policy associated with at least one context based on the property-retrieval history. The method includes updating the policy associated with the at least one context based on the analysis, and transferring data corresponding to the at least one context based on the policy.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented in accordance with disclosed embodiments;

FIG. 2 depicts a functional block diagram of a client-based system in accordance with disclosed embodiments;

FIG. 3 depicts a functional block diagram of a server-based system in accordance with disclosed embodiments; and

FIG. 4 depicts a flowchart of a process in accordance with disclosed embodiments.

### DETAILED DESCRIPTION

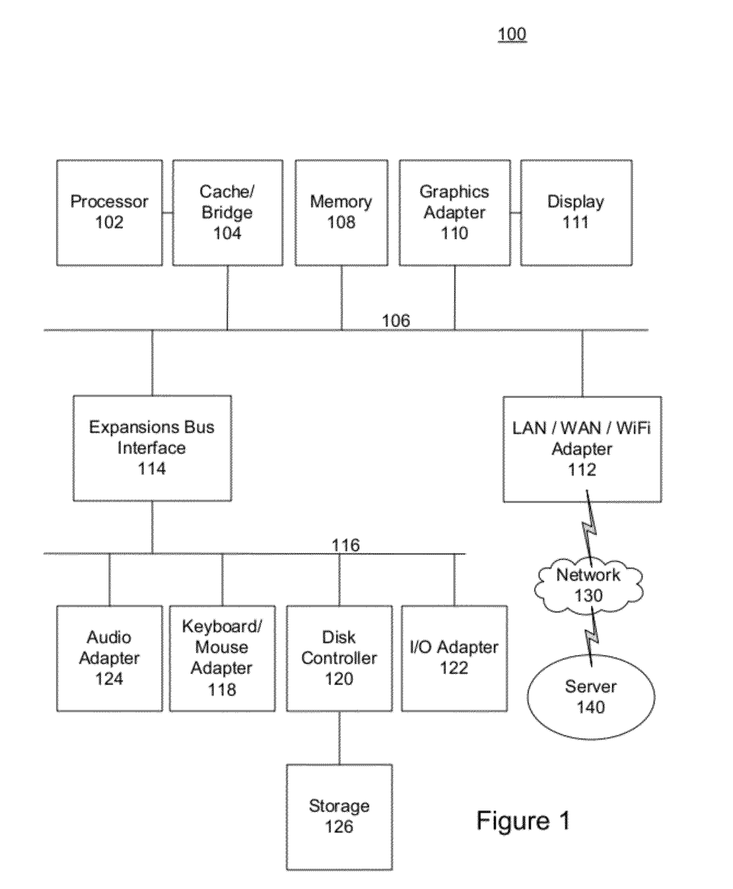

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Unnecessarily frequent or high-volume communications between data processing systems, such as between a client system and a server system, can result in high latency environments and in very poor performance. It is therefore advantageous to send information in fewer communications between the client and the server, particularly in high latency environment. Determining how much information to send can be difficult, since sending too much information consumes system resources unnecessarily and may lead to poor scalability and performance, and sending to little information can result in poor performance due to network latency.

System performance is a major concern for all client-server applications. Optimizing the “chattiness” between the client and server will help the performance and end user experience.

When a data object is sent from the server to the client, the server has several options with regard to sending the properties associated with the object. The server can send all the properties automatically; it can send a subset of the properties configurable via a policy file; or it can send no properties initially and let the client get the properties as needed.

If the object has very few properties and their evaluation is not expensive, the first option is often the most efficient. If the end users always work with a specific subset of the object properties, the second option works very well. The last option causes additional client/server chattiness if the end user needs to access the object properties and the client system must therefore request them separately.

In many cases, sending a subset of the properties is the most efficient approach. Typically the subset is specified via a static policy file. The policy file is set up by the application developer/administrator based on the purpose of the object and the understanding of the usage pattern of the end users. In many situations determining which properties is hard to do and becomes a “best guess” effort.

Applications can define the subset of properties in a policy file to transfer only the required subset of properties to the client. When a pre-defined policy is specified, the applications have the extra burden to keep the code and the policy in sync. This is not always feasible, since multiple applications may require different set of properties on the same object, the role of the end user may influence the set of properties that should be transferred, the policy may have to vary based on customer extensions to the object model or the client for optimal scalability and performance, or for other reasons.

Disclosed embodiments include systems and methods for improved policy-based property transfer between two data processing systems such as a client system and a server system.

FIG. 1 depicts a block diagram of a data processing system in which an embodiment can be implemented, for example as a CAD or PLM system configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. One or both of data processing system 100 and server system 140 can be configured to perform the processes described herein.

The terms “client” and “server” as used herein are meant to generally refer to two different systems communicating data between them, and are not meant to imply architectural or functional limitations unless specifically so described. Various embodiments can include communications between a client and server, a server and a database system, two servers, two clients, or otherwise, and these alternatives are all intended to fall within the client/server descriptions used herein.

Disclosed embodiments include systems and methods that manage a dynamic object property policy that can be customized based on usage context and history. As used herein, an object property policy can be implemented as a file containing the list of properties associated with an object that need to be populated by default when the object is sent from the server to the client.

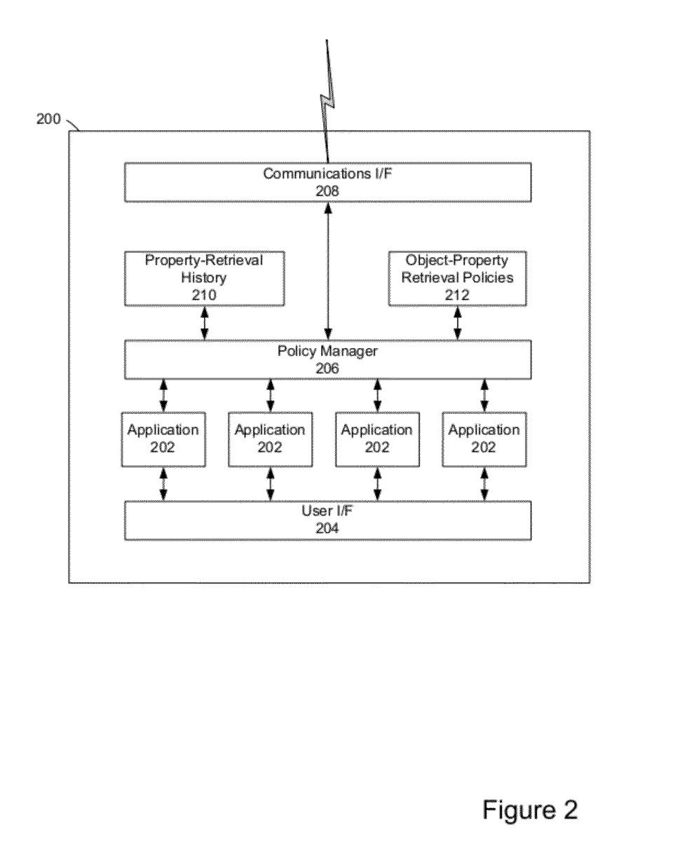

FIG. 2 depicts a functional block diagram of a client-based system in accordance with disclosed embodiments. In this example, client data processing system 200 can execute a plurality of applications 202. Each of the applications 202 can interact with a user via user interface 204. Each of the applications 202 communicate with a server system (not shown) over a communications interface 208.

As depicted here, a policy manager 206 is used to control which properties associated with an object are returned from the server system when requested by an application 202. The policy manager 206 uses stored object-property retrieval policies 212, and maintains a stored property-retrieval history 210 as described in more detail below, and otherwise asks as a “listener” for object-property calls. Other elements of system 200 not necessary for an understanding of the disclosure are not described here.

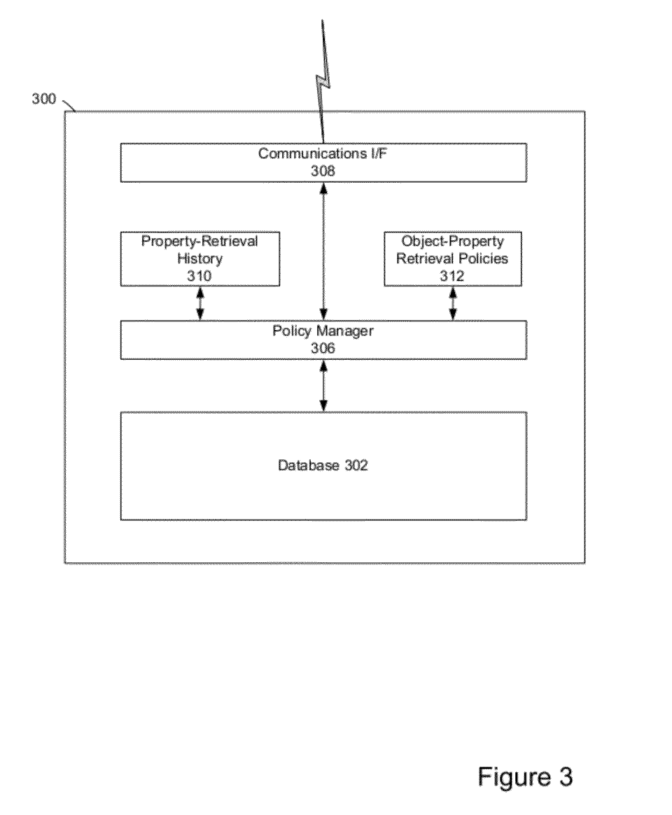

FIG. 3 depicts a functional block diagram of a server-based system in accordance with disclosed embodiments. In this example, server data processing system 300 maintains a database 302 of objects and properties. Database 302 can be implemented as a single database, or multiple databases, and stores objects and associated properties for one or more applications that might be executed on one or more client systems (not shown). The database 302 can communicate with the client systems over a communications interface 308.

As depicted here, a policy manager 306 is used to control which properties associated with an object are returned from the server system 300 when requested by an application on a client system. The policy manager 306 uses stored object-property retrieval policies 312, and maintains a stored property-retrieval history 310 as described in more detail below, and otherwise asks as a “listener” for object-property calls. In some embodiments, the property-retrieval history 310 and object-property retrieval policies 312 are stored in database 302.

The systems of FIGS. 2 and 3 can be used together or alternatively in different implementations.

When an application is first deployed or used on a data processing system, the application has an initial policy for use in transferring objects and properties to client systems, which can be stored in object-property retrieval policies 212 or 312. The initial policy can be simple and may not transfer any properties, may transfer an initial subset of properties (using a best guess approach), or may transfer all the properties. In a non-limiting example, the policy-management functions described herein can be performed by one or more server systems in communication with one or more client systems, where client systems, such as client 200, request data objects from a database 302 of the server systems 300 as users are using an arbitrary application. Generic references to “the system” can include one or more server systems or client systems, depending on implementation, and is not intended to be limiting unless otherwise specified.

As users use the application, the system keeps track of which properties have been accessed on a given object for a given set of circumstances. The circumstances can include things such as which application is accessing data, the user, the role of the user, and others. The property history can include the object, application, properties, other circumstances, or other data that helps determine the context in which particular properties are required for each application and/or object. The property history can be stored in property-retrieval history 210 or 310.

As the system is used over a period of time, the system develops a policy for each circumstance that is maintained over time, and stores this dynamic policy in the object-property retrieval policies 212 or 312. Once this policy is built, the system uses this dynamically-built policy to load the right set of properties when each object is retrieved or accessed, hence optimizing system performance and avoiding the problem of keeping the policy in synch with the code manually.

In the case where the user has flexibility to display more or less properties in the client system display, for example showing more or less columns in a table, the policy can be updated over time based on the user's settings. Thus the system can self-adjust the policy to provide the best performance possible tailored to the specific use.

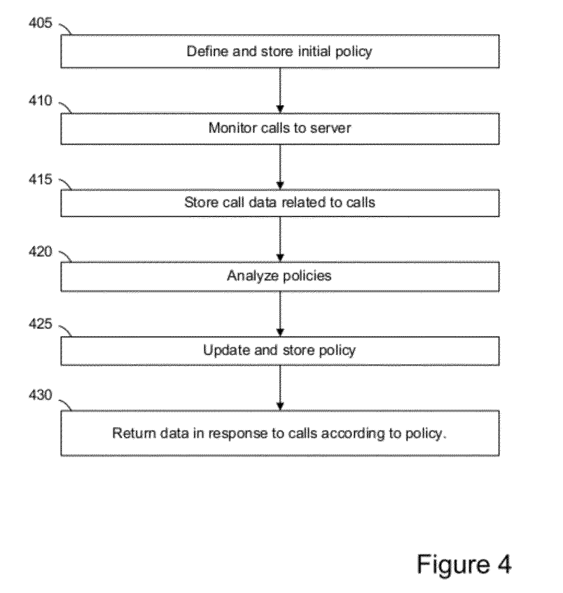

FIG. 4 depicts a flowchart of a process in accordance with disclosed embodiments.

In one exemplary embodiment, the system defines an initial policy including initial configuration items (step 405). The initial configuration can include the contexts based on which property policies are defined, or defining initial policies corresponding to each expected context. Examples of contexts are a user identified, a user role, the application making the call to retrieve the objects or properties, and permutations and combinations of the above. The initial configuration can also include an initial set of property policies that should be used for each of the contexts. The initial policy can be stored in or with object-property retrieval policies 212 or 312; the initial policy can include a plurality of policies each corresponding to an application or context that is expected to retrieve data.

The system monitors, “listens to”, or otherwise tracks calls to the server to retrieve properties associated with an object (step 410) using a listener or callback pattern, and the calls can be to a database on the server. This step can include receiving the call by the server, in server-based embodiments. Each call can be a request for an object or a request for properties associated with an object. In various embodiments, for a request for an object, the server returns and the client receives the object and any other data, including properties, defined by the current policy.

The system stores call data related to the calls based on the monitoring (step 415). The call data can include context, object type, and the properties that are being retrieved from the server, in either client-based or server-based processes, and can include the context object type and the properties that are being accessed in the client application in client-based processes in a property-retrieval history associated with each object, such as in property-retrieval history 210 or 310.

The system then analyzes the policy for a given context periodically or at a configurable trigger point, based on the property-retrieval history (Step 420). The trigger points can be, for example, a system down time, administrator or user manual invocation, after a configurable point in time such as a specific period of weeks or months, after a configurable number of object or property retrievals, or otherwise. On a trigger, the system can adjust the property policy to optimize further retrievals.

As part of this step, the system will analyze the property-retrieval history for each object in each specific application/user context. In various embodiments, this includes defining default properties to be returned in response to a call based on the context of the call. For each context, the system can determine mismatches between the policy in effect and the properties being retrieved. The mismatch could be either that the current policy is sending more properties than necessary or is sending fewer properties than needed. The system can determine if a minimum threshold of property retrievals has been exceeded. The system can determine the maximum threshold for additional properties that are unused but are being sent using the currently effective policy has been exceeded. In various embodiments, the client communicates to the server on what properties are being sent by the server in response to a call but are not being used or are otherwise not needed as default properties to be returned.

Once property-retrieval history for each object in each specific application/user context has been analyzed, the system can update the property policy for a given context based on the analysis, and store the updated policy in the object-property retrieval policies (step 425). The updated property policy can include the default properties and can include all properties that meet a property fetch criteria. This process thereby allows the system and the application to “self-tune” for optimal performance.

The client and server continue to exchange data as necessary; when a call is made to an object by a client, the call data is recorded and the object is returned along with any other data defined by the current policy (step 430). By updating the policy to respond with the data most likely needed according to the context of the object call or other call, disclosed embodiments provide a distinct technical advantage in reducing the number of calls and amount of data transmitted between client and server.

The various steps of processes described herein may be performed concurrently, sequentially, repeatedly, or in a different order unless otherwise described or claimed.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully-functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for data transfer, the method performed by a data processing system and comprising:
monitoring calls from a client system to a server system for properties associated with an object, each call having a context;
storing call data related to the calls as a property-retrieval history, including storing the context of each call;
analyzing a policy associated with at least one context based on the property-retrieval history;
updating the policy associated with the at least one context based on the analysis; and
transferring data corresponding to the at least one context based on the policy.

2. The method of claim 1, wherein updating the policy includes defining default properties to be returned in response to a call based on the context of the call.

3. The method of claim 1, further comprising defining initial policies corresponding to each context.

4. The method of claim 1, wherein each context includes at least one of a user identifier, a user role, and an application that is making the call for that context.

5. The method of claim 1, wherein monitoring calls includes receiving the calls by a server system.

6. The method of claim 1, wherein the calls are also calls for an object.

7. The method of claim 1, wherein the call data also includes an object type and the properties associated with each call.

8. The method of claim 1, wherein the analysis is performed at a configurable trigger point.

9. The method of claim 8, wherein the trigger point is a configurable number of property calls.

10. A data processing system comprising:
a processor; and
an accessible memory, wherein the data processing system is particularly configured to
monitor calls from a client system to a server system for properties associated with an object, each call having a context;
store call data related to the calls as a property-retrieval history, including storing the context of each call;
analyze a policy associated with at least one context based on the property-retrieval history;
update the policy associated with the at least one context based on the analysis; and
transfer data corresponding to the at least one context based on the policy.

11. The data processing system of claim 10, wherein updating the policy includes defining default properties to be returned in response to a call based on the context of the call.

12. The data processing system of claim 10, further comprising defining initial policies corresponding to each context.

13. The data processing system of claim 10, wherein each context includes at least one of a user identifier, a user role, and an application that is making the call for that context.

14. The data processing system of claim 10, wherein monitoring calls includes receiving the calls by a server system.

15. The data processing system of claim 10, wherein the calls are also calls for an object.

16. The data processing system of claim 10, wherein the call data also includes an object type and the properties associated with each call.

17. The data processing system of claim 10, wherein the analysis is performed at a configurable trigger point.

18. The data processing system of claim 17, wherein the trigger point is a configurable number of property calls.

19. A non-transitory computer-readable medium encoded with computer-executable instructions that, when executed, cause a data processing system to perform the steps of:
monitoring calls from a client system to a server system for properties associated with an object, each call having a context;
storing call data related to the calls as a property-retrieval history, including storing the context of each call;
analyzing a policy associated with at least one context based on the property-retrieval history;
updating the policy associated with the at least one context based on the analysis; and
transferring data corresponding to the at least one context based on the policy.

20. The computer-readable medium of claim 19, wherein updating the policy includes defining default properties to be returned in response to a call based on the context of the call.
